(19) United States
(12) Patent Application Publication
(10) Pub. No.: US 2005/0057942 A1
(43) Pub. Date: Mar. 17, 2005

(54) Illumination and reflective strips

(76) Inventors: Chris Mako, Walnutport, PA (US); Eva Mako, Walnutport, PA (US)

Correspondence Address: BLANK ROME LLP, 600 NEW HAMPSHIRE AVENUE, N.W., WASHINGTON, DC, 20037, US

(21) Appl. No.: 10/660,496

(22) Filed: Sep. 12, 2003

(51) Int. Cl. G02B 6/04

(52) U.S. Cl. 362/554

(57) ABSTRACT

A modular reflective and light emitting illumination strip that includes a first side made of a reflective material having holes therein, and a plurality of fiber optic cables secured to a single light emitting diode (LED) within the illumination strip to emit light through the holes. A second side of the illumination strip includes an attaching surface, such as a magnetic or Velcro® layer, for securing the illumination strip to articles, such as clothes, automobiles, poles, etc. The illumination strip further includes a male and female connector on opposite ends of the strip, so that multiple illumination strips may be interconnected to one another. This allows multiple illumination strips to be assembled into various shapes and sizes to suit a user's particular purpose.

### FIELD OF INVENTION

The present invention relates generally to modular devices providing illumination or light reflectance. More particularly, the present invention relates to strips having reflective surfaces and fiber optic lights that can be interconnected to provide an illumination device of varying shape and size.

### BACKGROUND OF THE INVENTION

Since the development of laminates and strips of fibers having light reflective characteristics, those materials have found their way into myriads of products. Likewise, since the development of light-emitting diodes (LEDs) and fiber optic cables, uses for LEDs and fiber optic cables have proliferated and can be found in countless commercial goods. Because of the synergistic nature of light reflecting and light-emitting devices, combinations of those devices have also been developed for various uses. Further advancements in electronic circuitry and materials processing have provided product developers and manufacturers with even more applications in which to combine light-reflective and light-emitting devices. Even today, new uses for light reflecting and light-emitting devices are being developed to satisfy various industrial, occupational, individual and societal needs.

Light reflective materials are commonly found on garments, such as firefighting suits, safety vests, belts, bands and footwear, to name just a few. U.S. Pat. No. 4,365,354, for example, discloses an athletic vest having parallel and spaced apart reflective strips across the chest. U.S. Pat. No. 4,601,538 discloses a reflective safety belt with a “hooks and loops”-type fastener (i.e., Velcro®) for easy donning and doffing.

Light-emitting devices, such as LEDs, are also commonly found on safety garments. U.S. Pat. No. 4,523,258, for example, discloses a safety belt having a plurality of spaced apart LEDs on a flexible circuit board, a power supply and a switch for energizing the LEDs. That patent discloses that the LEDs are divided into two groups such that the two groups are alternately energized on and off in a flashing manner. U.S. Pat. Nos. 4,774,642 and 4,839,777 disclose a jacket garment having vertically-oriented arrangements of LEDs electrically connected to a harness attached to the garment. U.S. Pat. No. 4,812,953 discloses an illuminated safety band attachable with a hooks and loops fastener.

Light-emitting devices, including those having LEDs, are not limited to safety garments. U.S. Pat. No. 5,585,783 discloses an upright stationary marker capped with a light-emitting source consisting of a plurality of LEDs and circuitry for enabling steady-on, off and flashing illumination. The LEDs are housed in a transparent or a colored translucent housing.

Combinations of light reflecting and light-emitting devices are also found on garments and other goods. For example, U.S. Pat. No. 6,059,414 discloses a strip attachable to a garment, each strip having rows of reflective material arranged behind rows of LEDs. Other patents disclose bicycle safety lights/reflectors, automobile signals, and cone-shaped road markers having a combination of reflective materials or panels and light sources, including LEDs.

One problem associated with devices combining both reflective materials and LEDs is that the distinction or contrast between the reflective portion and the LEDs can be blurred. That is, if the incident light intensity is high, the reflected light can have a luminance approaching that of the light projected from the LEDs. That can render the light from the LEDs visually indistinct, especially if the light emitted is near the same wavelength as the reflected light. That is an important consideration when designing devices such as display signs or signals.

To overcome that problem, a high-intensity LED may be used. However, in most instances, the higher the LED output luminance, the lower the viewing angle. An encapsulant can be applied to the LED to diffuse the light, but that reduces the overall luminance at all viewing angles. An LED producing a different color light than the reflected light could be used, but the luminance from one of the sources can still obliterate the other source.

Another problem is that prior art illumination devices typically use a plurality of LEDs so that each LED must be separately powered. In devices having several LEDs, this may require providing large amounts of energy, and consequently, a large power source.

Additionally, the reflective or light emitting devices disclosed in the prior art are designed to meet specific needs, limiting their use in other situations. For example, the illuminating devices of U.S. Pat. No. 4,839,777 are fixedly attached to a garment to be worn by an individual. The pattern of the light emitting devices and the manner in which the light emitting devices are worn are fixed, and there exists no means in which to transfer the light emitting devices to another garment, or alter their pattern.

### SUMMARY AND OBJECTS OF THE INVENTION

The invention is directed to a modular reflective and illuminating device comprising flexible individual strips having a first side made of a reflective material and having holes therein, and a second side having an attachment surface, such as a magnetic or Velcro® section for securing the strip to various objects, such as street lights and poles, safety cones, clothes, etc. The interior of the device includes a light emitting diode (LED) and associated fiber optic cables connected thereto. The single LED provides the light source for each fiber optic cable, the ends of which extend to the holes in the first side of the flexible strip to shine therethrough. The fiber optic cables transfer the light from the LED to the holes to illuminate the first side of the strip.

Each reflective and illuminating strip is capable of being interconnected with other similar strips to form various shapes, symbols or words in order to better communicate the presence of nearby hazards. The strips can be formed into such shapes as an arrow, which can point to the location of a hazard, or words which can provide instructions, such as “stop” or “turn.” The flexibility of each strip and its ability to be interconnected with other strips allows them to form almost any shape or symbol so that they may be used in a variety of environments and situations.

An electrical circuit is provided in the interior of the strip and provides the electrical power to the LED. The circuit also provides an interconnecting mechanism, allowing several reflective and illuminating strips to be electrically coupled to one another. In that way, a single power source, such as a battery, provides the electricity for the entire device, whether it be a single reflective and illuminating strip, or a plurality of interconnected strips.

In view of the foregoing, it should be apparent that there exists a need in the art for a beacon having both light reflective and light-emitting portions that are visibly distinct from each other under various luminous intensities, and that can be interconnected to form various shapes, symbols and words to be used in connection with safety garments, information displays, vehicles, markers and other goods.

It is also apparent that there exists a need for an energy efficient illuminating device wherein a single LED provides the light for multiple light sources, thus reducing the number of LEDs needed, and consequently, the amount of energy needed.

It is, therefore, an object of the present invention to provide a powered strip that is attachable to or integrated with a support structure in which the strip has a portion that reflects light from a wide range of incident angles and has a portion that produces visibly distinct light.

More particularly, it is an object of the present invention to provide a strip with reflective surfaces and a single LED which provides the light for a plurality of fiber optic cables.

It is another object of the present invention to provide a safety strip that is modular and configurable for various applications, each strip having interconnects and splitters for combining various strips together, and also having fasteners for securing the strip to a support. In that manner the safety strip can be adapted to be attached to garments, vehicles, poles, and other stationary and mobile structures by interconnecting two or more strips together.

With these and other objects, advantages and features of the invention that may become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a top view of an illumination strip of the present invention;

FIG. 2 is a bottom view of the illumination strip of the present invention;

FIG. 3 is a side cut-away view of the invention showing fiber optic cables adjacent a cover of the illumination strip;

FIG. 4A shows the attachment of the illumination strip to a power source in the present invention;

FIG. 4B shows the attachment of the illumination strip to a power source in a second embodiment of the invention;

FIG. 5A shows a first exemplary use of the invention where multiple illumination strips are connected to spell out a word;

FIG. 5B shows a second exemplary use of the invention where the illumination strips are attached to a pole;

FIG. 5C shows a third exemplary use of the invention where the illumination strip is attached to garment in the shape of a triangle; and

FIG. 5D shows a fourth exemplary use of the invention where the illumination strips are attached a safety cone in the shape of an arrow.

### DETAILED DESCRIPTION OF THE PREFERRED EMBODIMENT

Referring now to the several drawing figures in which identical elements are numbered identically throughout, a description of the preferred embodiment of the present invention will be provided. The preferred embodiment of the invention is described for illustrative purposes, it being understood that the invention may be embodied in other forms not specifically shown in the drawings or described hereinafter.

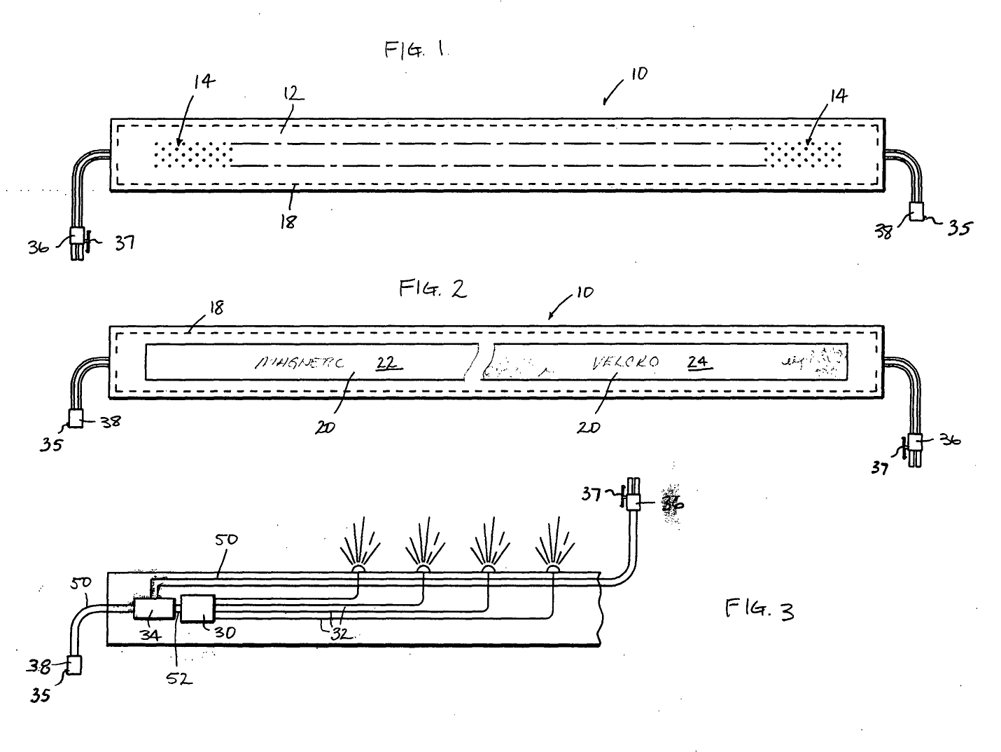

Referring now in detail to the drawings, FIG. 1 shows a top view of an illumination strip 10 of the present invention having a reflective top covering 12 with a plurality of holes or openings 14 therein. FIG. 2 shows a bottom view of the illumination strip 10 having a non-illuminating back covering 16 with an attaching surface 20 thereon. The top and bottom coverings 12 and 16 are secured together around their perimeter by stitches 18, RF welding or any other well known mechanism.

The attaching surface 20 on the rear of the illumination strip 10 allows it to be secured to garments and structures, such as, jackets, shirts, pants, cars, boats, poles, doors, safety cones, fire hoses or just about any other imaginable article. The attaching surface 20 can comprise one of any number of methods, including but not limited to, using an elongated strip of magnetic material, Velcro® or other material which secures the illumination strip 10 to an object. Other methods of attachment include using belt hooks or adhesives.

FIG. 2 shows, by way of example, magnetic 22 and Velcro® 24 attaching surfaces 20, but it should be understood that the elongate strip is preferably made of a single material and that the two alternate embodiments shown in FIG. 2 are for illustrative purposes. Additionally, it should also be understood the invention contemplates using a variety of attaching means, and is not intended to be limited to elongate strips, and more particularly, not intended to be limited to elongate strips made of a magnetic or Velcro® material.

FIG. 1 shows a first embodiment of the invention where the top covering 12 includes small holes 14 therein, and a light source is placed underneath the top covering 12, so as to emit a light through the holes 14. As shown in FIG. 3, the light source comprises a single light emitting diode (LED) 30, or other similar device, such as an infrared or xenon bulb, attached to a plurality of fiber optic cables 32.

An end of each fiber optic cable 32 is attached to the LED 30, which provides the light that is carried by the plurality of fiber optic cables 32 to the holes 14 in a top covering 12. In that way, each fiber optic cable 32 does not require its own individual LED, and allows the single LED 30 to provide the light for all the fiber optic cables 32. Thus, power is needed only for the single LED 30, and not multiple LEDs, as is the case in the prior art devices.

Each fiber optic cable 32 is placed within the illumination strip 10 so that its end is placed adjacent to or slightly protruding through the holes 14. The fiber optic cables 32 augment the reflective top covering 12 to increase the illumination strip's effectiveness and visibility. Additionally, an electronic control device 34 is connected to the LED 30 and can be programmed to have the LED 30 remain lit at all times or flash intermittently at predetermined intervals to further increase the illumination strip's 10 effectiveness.

The LED 30 is designed to give off a specific color emission, which is carried by the fiber optic cables 32. The dominant wavelength is a quantitative measure of an LED color as perceived by the human eye and is usually measured in nanometers (a billionth of a meter). The luminous intensity of the light emission is a measure of the amount of light generated at a specified electrical current. Luminance is the density of luminous flux leaving a surface in a particular direction. It is the quotient of the intensity of the source in the direction of measurement by the projected area of the source in that direction. The viewing angle is the angle of light emissions perceived by the human eye measured from a line normal to the surface of the fiber optic cable. Generally, the viewing angle decreases with luminous intensity. A diffuser can be used to scatter the light emitted and widen the viewing angle, resulting in a more even and wider distribution of the light. A diffusing encapsulant covering the LED 30 may reduce the luminous intensity of the device. Diffused LEDs are ideal for applications where the LED acts as an indicator, rather than an illuminator. The color, luminosity and diffusion of the LED 30 and fiber optic cable 32 can be selected to match the desired purpose of the illumination strip 10.

As shown in FIGS. 1-3, each illumination strip 10 has connectors on its ends, preferably a male plug 36 and female receptacle 38, such that multiple illumination strips 10 can be connected together to form a long illumination strip, as shown in the exemplary embodiment of FIG. 5A. The female receptacle 38 includes a detent 35 that is adapted to engage a latch member 37 on the male plug 36. The male plug 36 of a first illumination strip 10 is connected to the female receptacle 38 of a second illumination strip and they are secured together via the detent 35 and latch member 37 discussed above. The illumination strips 10 can be disconnected by pressing the latch member 37 so that it releases the detent 35.

The male plug 36 on one end of the illumination strip 10 is connected by an electrical line 50 to the female receptacle 38. A parallel electrical line 52 is connected to the electrical line 50 to connect the male plug 36 to the electronic control device 34 and LED 30. Because of the electrical line 50, the male plug 36 of a first illumination strip can be connected to the female receptacle 38 of a second illumination strip, and electrically connect the two illumination strips. In this way, any number of illumination strips may be connected in series to one another to form a single illumination device made up of a plurality of illumination strips 10.

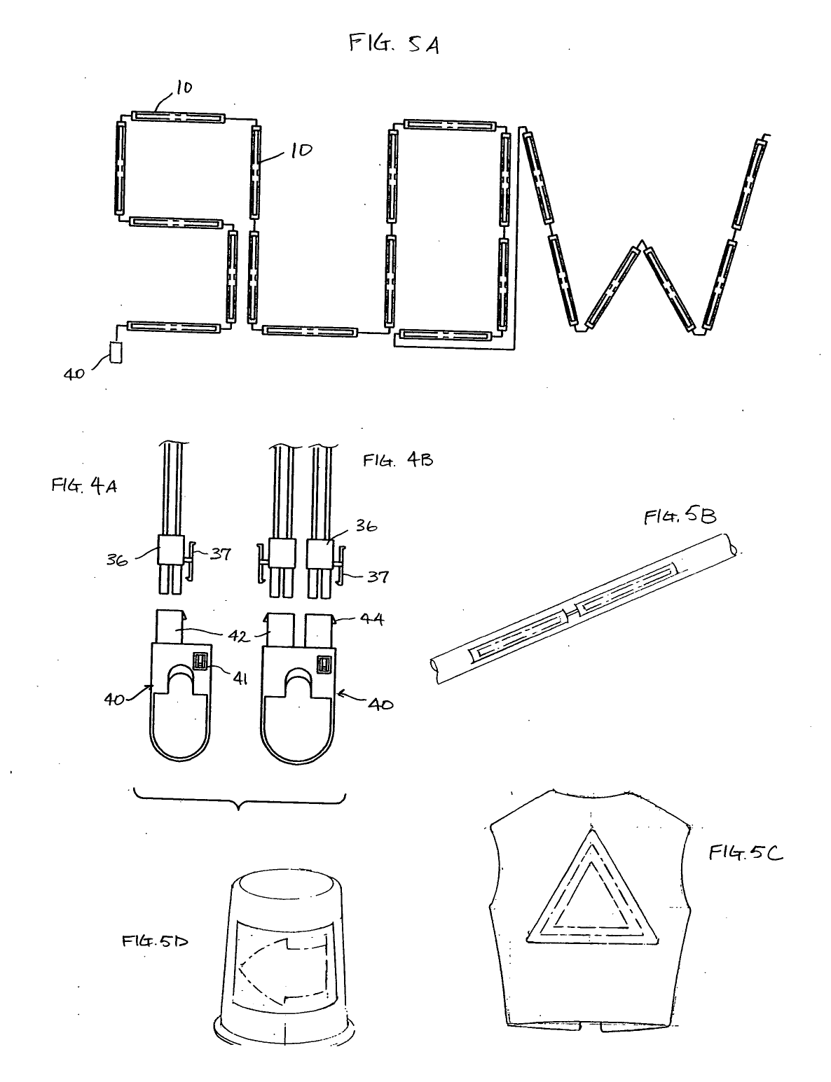

The interconnected illumination strips also allow a single power source to supply energy to the entire device. FIG. 4A shows a battery 40 having a female receptacle 42 that mates with the male plug 36 of the illumination strip 10. The female receptacle 42 of the battery 40 includes a detent 44, identical to the detent 35 on the female receptacle 38 of the illumination strip 10. FIG. 5A shows how the single battery 40, connected at one end of a plurality of illumination strips 10 can power all the illumination strips. In that way, only a single battery 40 is needed whether an illumination strip is used independently or in conjunction with several others.

Additionally, because the electrical line 52 is parallel to the electrical line 50, if the LED 30 fails, the electrical circuit 50 would continue to provide power to an LED in any subsequent illumination strips 10.

The above connection system allows several illumination strips 10 to be interconnected to form a long illumination strip or to spell out words or symbols, as shown by example in FIGS. 5A-5D. FIG. 5A shows illumination strips that have been connected to form a single long illumination strip and FIG. 5B shows several illumination strips 10 have been connected to spell out the word “SLOW.” Additionally, FIGS. 5C and 5D show additional symbols which can be formed with multiple illumination strips 10. Although the details of each illumination strip are not shown in these figures, they are readily inferred. In that way, the illumination strips 10 are able to alert passersby of their presence, and additionally, communicate further information.

FIGS. 4A and 4B show two alternative embodiments of a power source 40, which is adapted to connect to one end of each illumination strip 10. The power source 40 is preferably a battery, but can be any source such as solar cell, AC/DC plug-in, etc. The figures show the battery 40 having an on-off switch 41, and a female receptacle 42 which mates with a corresponding male plug 36 on the illumination strip 10. It should be understood that the battery 40 could incorporate a male plug, rather than a female receptacle, and continue to be within the scope of the invention.

Although only preferred embodiments are specifically illustrated and described herein, it will be appreciated that many modifications and variations of the present invention are possible in light of the above teachings and within the purview of the appended claims without departing from the spirit and intended scope of the invention.

1. A modular illumination strip comprising:
an illumination strip with a top side having a reflective surface and a plurality of holes therein;
an electrical circuit having a first end and second end, the first and second ends having corresponding connectors that are adapted to connect to another illumination strip; and
a light source electrically connected to the electrical circuit and placed within the illumination strip, the light source emitting light through the holes of the illumination strip.

2. The modular illumination strip of claim 1, wherein:
the light source is connected to the electrical circuit in parallel so that if the light source fails, the electrical circuit will continue to provide energy between the first and second ends.

3. The modular illumination strip of claim 1, wherein:
the light source comprise a single light source connected to a plurality of fiber optic cables which transfer the light from the light source to the holes in the top side of the illumination strip.

4. The modular illumination strip of claim 3, wherein:
the light source in a light emitting diode.

5. The modular illumination strip of claim 4, wherein:
the light source is programmable to blink in a predetermined sequence.

6. The modular illumination strip of claim 1, wherein:
the connectors are one of a corresponding male and female receptacle which are configured to mate with each other.

7. The modular illumination strip of claim 1, wherein:
the illumination strip includes a bottom side having an attachment surface adapted to secure the illumination strip to an article, the attachment surface being one of an adhesive, magnetic strip, or hook and latch-type strip.

8. The modular illumination strip of claim 1, wherein:
the illumination strip is bendable so that it may be formed into various shapes.

9. An illumination system comprising:
a plurality of illumination strips, each strip have a first illumination side with a plurality of holes therein and a second non-illuminating side, an electrical circuit within the illumination strip extending between a first end and a second end, the first end and second end having a male plug and female receptacle, respectively, and a light source within the illumination strip emitting a light through said holes;
wherein the plurality of illumination strips are electrically and physically connected to one another by mating the male plug of a first illumination strip to the female receptacle of a second adjacent illumination strip.

10. The illumination system of claim 9, further comprising:
a power source attached to one of the male plug or female receptacle on a first illumination strip, said power source providing the electrical power to the light source in each illumination strip.

11. The illumination system of claim 9, wherein:
each illumination strip comprises a plurality of fiber optic cables attached to the light source, the fiber optic cables transferring the light emitted from the light source to the holes in the illumination strip.

12. The illumination system of claim 9, wherein:
the non-illuminating side includes a fastening surface which secures the illuminating strip to an article.

13. The modular illumination strip of claim 9, wherein:
the light source is programmable to blink in a predetermined sequence.

14. The modular illumination strip of claim 9, wherein:
each illumination strip is bendable so that it may be formed into various shapes.
